(19) United States
(12) Patent Application Publication
(10) Pub. No.: US 2026/0201077 A1
(43) Pub. Date: Jul. 16, 2026

(54) METHOD FOR EXTRACTING XYLOGLUCAN FROM THE PRIMARY WALLS OF PLANT CELLS

(71) Applicants: FUNCELL, Giéres (FR); Centre National de la Recherche Scientifique, Paris (FR)

(72) Inventors: Josselin Mante, Giéres (FR); Laurent Heux, Paris (FR); Julien Leguy, Giéres (FR)

(21) Appl. No.: 19/132,514

(22) PCT Filed: Nov. 24, 2023
(86) PCT No.: PCT/EP2023/082962

§ 371 Date: May 23, 2025

(30) Foreign Application Priority Data
Nov. 25, 2022 (FR) FR2212319

(51) Int. Cl. C08B 37/00

(52) U.S. Cl. CPC C08B 37/0057; C08B 37/0003

(57) ABSTRACT

A method for extracting xyloglucan contained in the primary walls of plant cells, and more particularly of dicotyledonous plants, includes mixing primary walls of plant cells with a first aqueous solution and to which a strong base is added, which leads to the formation of a first liquid residue and a first solid product, this first solid product comprising mainly holocellulose. The first product is mixed with a second solution, the second solution comprising the strong base, which leads to the separation of the cellulose and xyloglucan contained in the first product. The method uses a relatively limited number of steps and uses chemical compounds with low human and environmental toxicity.

### CROSS-REFERENCE TO RELATED APPLICATIONS

This application is a national phase entry under 35 U.S.C. § 371 of International Patent Application PCT/EP2023/082962, filed Nov. 24, 2023, designating the United States of America and published as International Patent Publication WO 2024/110624 A1 on May 30, 2024, which claims the benefit under Article 8 of the Patent Cooperation Treaty of French Patent Application Serial No. FR2212319, filed Nov. 25, 2022.

### TECHNICAL FIELD

The present disclosure relates to the field of extracting a hemicellulose from the primary walls of plant cells. Notably, the present disclosure relates to a method for extracting xyloglucan contained in the primary walls of plant cells. In this respect, the present disclosure proposes a method for extracting xyloglucan in polymer form, which is compatible with the environmental constraints and has sufficient yield for use thereof on an industrial scale.

### BACKGROUND

Tamarind seeds are an often-preferred source of xyloglucan. This choice is notably motivated by the abundance of seeds, the abundance of xyloglucan in these same seeds but also by the simplicity of the method for extracting xyloglucan from tamarind seeds.

Nevertheless, there is now a desire to diversify the supply sources. From the interesting and/or alternative supply sources, agri-food by-products are of particular interest. Notably, these by-products comprise a significant amount of primary walls of plant cells, which comprise xyloglucan.

By way of example, apple pomace or else citrus fruit by-products derived from juice extraction are of particular interest among the agri-food by-products to be considered for xyloglucan extraction.

In this respect, document [1] cited at the end of the description discloses a method for extracting xyloglucan from the primary walls of apple pomace cells.

However, this extraction method involves a relatively large number of steps, as well as low yields and purities, thus making it less compatible with industrial implementation of xyloglucan extraction.

Furthermore, the extraction method considered in document [1] also comprises a delignification step with sodium chlorite (NaClO₂), which is known for its toxicity, notably its environmental toxicity.

Finally, the amounts of soda considered during the implementation of this method are relatively large.

Thus, one aim of the present disclosure is to propose a method for extracting xyloglucan from the primary walls of plant cells, which has a limited number of steps compared with methods known in the state of the art while allowing efficient extraction (high yields and high purities) of xyloglucan in polymer form (high molecular weights).

Another aim of the present disclosure is to propose a method for extracting xyloglucan from the primary walls of plant cells and whose high yield is compatible with industrial implementation.

Another aim of the present disclosure is also to provide a method for extracting xyloglucan from the primary walls of plant cells that uses much smaller amounts of base than methods known in the state of the art.

### BRIEF SUMMARY

The aims are, at least in part, achieved by a method for extracting xyloglucan contained in the primary walls of plant cells, the method comprising carrying out the following steps:
a) a first step, which comprises mixing native or extracted primary walls of plant cells with a first aqueous solution and to which a strong base is added at a concentration of between 0.1 mol/L and 0.75 mol/L, advantageously between 0.25 mol/L and 0.5 mol/L,
the execution of the first step leading to the formation of a first liquid residue and a first solid product, this first solid product comprising mainly holocellulose; and
b) a second step of mixing the first product with a second solution, the second solution comprising the strong base at a concentration of between 1 mol/L and 3 mol/L, advantageously between 2 mol/L and 3 mol/L, the second step leading to the separation of the cellulose and xyloglucan contained in the first product.

According to one embodiment, the first step a) executed in two successive sub-steps that comprise:
a1) a first sub-step that comprises mixing the plant cells with the first aqueous solution, the mixture of the first aqueous solution with the plant cells having a pH of between 3 and 7, advantageously between 4 and 7, even more advantageously between 4 and 5;
a2) a second sub-step that comprises adding the strong base, at a concentration of between 0.1 mol/L and 0.75 mol/L, advantageously between 0.25 mol/L and 0.5 mol/L, to the mixture obtained at the end of the first sub-step a1).

According to one embodiment, the first aqueous solution comprises an acid species so that the pH resulting from the mixture of the first aqueous solution and the plant cells is between 3 and 7, advantageously between 4 and 7, even more advantageously between 4 and 5.

According to one embodiment, the acid species comprises at least one of the species selected from: citric acid, acetic acid, nitric acid.

According to one embodiment, the pH, which may be between 3 and 7, advantageously between 4 and 7, even more advantageously between 4 and 5, of the mixture of the first aqueous solution and the plant cells results from the presence of acid compounds in the plant cells.

According to one embodiment, the first sub-step a1) is carried out at a temperature greater than 80° C. and is of a duration greater than 30 min.

According to one embodiment, the second sub-step a2) is carried out at a temperature greater than 60° C. and is of a duration greater than 1 hour.

According to one embodiment, the second step b) is carried out at a temperature greater than 50° C. and is of a duration greater than 1 hour.

According to one embodiment, the strong base comprises at least one of the following compounds selected from: sodium hydroxide (NaOH), potassium hydroxide (KOH).

According to one embodiment, the method does not use sodium chlorite, calcium chloride or any other oxidant allowing the removal of lignin.

According to one embodiment, the plant cells are plant cells of a dicotyledonous plant.

According to one embodiment, the dicotyledonous plant comprises one of the following species selected from: apples or citrus fruits.

According to one embodiment, the method is limited to the execution of the first step a) and of the second step b).

### BRIEF DESCRIPTION OF THE DRAWINGS

Other features and advantages of the present disclosure will become apparent from the following detailed description of example embodiments of the present disclosure with reference to the appended figure, wherein:

FIG. 1 is a schematic illustration of the method for extracting xyloglucan contained in the primary walls of plant cells;

FIG. 2 graphically illustrates the extraction yields of xyloglucan from the first product along the vertical axis based on the concentration of strong base, notably sodium hydroxide, (in mol/L) along the horizontal axis, notably, this graph represents the yields for different temperatures, and more particularly carried out at 20° C., 35° C. and 70° C.;

FIG. 3 graphically shows the evolution of the molar mass of xyloglucan obtained at the end of step b) based on the concentration of strong base and for different temperatures (20° C., 35° C. and 70° C.) at which step b) is carried out. Notably, the vertical axis marks the molar mass (in “103 g/mol”) based on the concentration of strong base, notably sodium hydroxide, (in mol/L) along the horizontal axis, more particularly, the “round” patterns represent the molar masses obtained at 20° C., the “triangle” patterns represent the molar masses obtained at 35° C., and the “diamond” patterns represent the molar masses obtained at 70° C.

### DETAILED DESCRIPTION

The present disclosure relates to a method for extracting xyloglucan Xg contained in the primary walls of plant cells, and more particularly dicotyledonous plants.

The method according to the present disclosure notably comprises a relatively limited number of steps and uses chemical compounds with limited human and environmental toxicity.

Notably the method according to the present disclosure comprises carrying out the following steps:
a) a first step consisting of the execution of the following two successive sub-steps:
a1) a first sub-step, which comprises mixing the plant cells with a first aqueous solution, the mixture of the first aqueous solution with the plant cells having a pH of between 3 and 7, advantageously between 4 and 7, even more advantageously between 4 and 5;
a2) a second sub-step that comprises adding a strong base, at a concentration between 0.1 mol/L and 0.75 mol/L, advantageously between 0.25 mol/L and 0.5 mol/L, to the mixture obtained at the end of the first sub-step a1);
the execution of these two sub-steps a1) and a2) leading to the formation of a first liquid residue PRL and a first solid product PPS, this first solid product PPS comprising mainly holocellulose;
b) a second step of mixing the first product with a second solution, the second solution comprising the strong base at a concentration of between 1 mol/L and 3 mol/L, advantageously between 2 mol/L and 3 mol/L, the second step leading to the separation of the cellulose Cell and xyloglucan Xg contained in the first product.

The execution of sub-step a1) is in some cases optional so that the first step can be limited to mixing the plant cells with a first aqueous solution and to which a strong base is added at a concentration of between 0.1 mol/L and 0.75 mol/L, advantageously between 0.25 mol/L and 0.5 mol/L. This situation notably arises when the plant cells have undergone a first operation, and notably pectin extraction.

In the rest of the description, it will be considered that the first step a) is executed in two sub-steps. However, a skilled person, on the basis of the present statement alone, will be able to consider a first step that comprises the mixing of native or extracted primary walls with a first aqueous solution and to which a strong base is added at a concentration of between 0.1 mol/L and 0.75 mol/L, advantageously between 0.25 mol/L and 0.5 mol/L. The execution of the first step a) leads to the formation of a first liquid residue and a first solid product, this first solid product comprising mainly holocellulose.

“Native” is understood to mean primary walls of untreated plant cells. In other words, “native” is understood to mean the primary walls of plant cells that have not undergone any chemical process, and notably no pectin extraction operation.

“Extracted” is understood to mean primary walls derived from untreated plant cells notably via a first operation, for example, a pectin extraction operation.

Thus, FIG. 1 is a schematic illustration of the method for extracting xyloglucan Xg contained in the primary walls of plant cells.

Notably, the method according to the present disclosure comprises the execution of a first step a). Notably, this first step a) comprises the execution of a first sub-step a1) and a second sub-step a2).

In this respect, the first sub-step a1) comprises mixing the plant cells with a first aqueous solution. Notably, the mixture of the first aqueous solution with the plant cells has a pH of between 3 and 7, advantageously between 4 and 7, even more advantageously between 4 and 5. According to one embodiment, the first aqueous solution comprises an acid species so that the pH resulting from the mixture of the first aqueous solution and the plant cells is between 3 and 7, advantageously between 4 and 7, even more advantageously between 4 and 5.

For example, the first aqueous solution may comprise citric acid and/or acetic acid and/or nitric acid. The present disclosure is not however limited to the consideration of these three acids, and the skilled person may consider any other weak or strong acid that is not toxic to humans or the environment.

Alternatively, the pH, between 3 and 7, advantageously between 4 and 7, even more advantageously between 4 and 5, of the mixture of the first aqueous solution and the plant cells may result from the presence of acid compounds in the plant cells.

The first sub-step a1) can advantageously be carried out at a temperature greater than 70° C., advantageously greater than 80° C. and even more advantageously greater than 85° C. Furthermore, the first sub-step a1) may be of a duration greater than 15 min, advantageously greater than 30 min, even more advantageously greater than 45 min.

By way of example, the first sub-step a1) can be carried out at a temperature equal to 90° C. and be of a duration equal to 1 hour.

The execution of sub-step a1) makes it possible notably to separate holocellulose on the one hand from a supernatant on the other hand. This supernatant comprises free sugars, oligosaccharides and pectins.

“Mild” acidity conditions (slightly acidic, pH greater than 3) make it possible to preserve the structure of holocellulose, and notably the xyloglucan Xg contained therein. It is understood that holocellulose comprises cellulose Cell and xyloglucan Xg (xyloglucan Xg being a hemicellulose).

The execution of the first sub-step a1) at a temperature greater than 70° C. also makes it possible to solubilize in the supernatant the starch likely to be present in the primary walls of the plant cells in question.

However, some pectins likely to be present in the primary walls of plant cells are not necessarily soluble in an acidic environment. Thus, and according to the present disclosure, it is proposed to solubilize these pectins in the supernatant by imposing base conditions on the mixture (sub-step a2)).

Thus, the first sub-step a1) is followed by a second sub-step a2), which comprises the addition of a strong base to the mixture formed during the first sub-step a1).

Notably, the second sub-step a2) is carried out so that the concentration of strong base is between 0.1 mol/L and 0.75 mol/L, advantageously between 0.25 mol/L and 0.5 mol/L.

The strong base in question may comprise at least one of the species selected from: sodium hydroxide (NaOH), potassium hydroxide (KOH).

Alternatively, the second sub-step a2) can be carried out at a temperature greater than 60° C., advantageously greater than 70° C., even more advantageously greater than 75° C.

Furthermore, the second sub-step a2) may be of a duration greater than 30 min, advantageously greater than 45 min and even more advantageously greater than 1 hour.

By way of example, the second sub-step a2) can be carried out at a temperature of 80° C. and be of a duration of 2 hours.

This second sub-step a2) results, in particular, in an extraction of pectins and proteins.

Without being bound by the following explanation, it is believed that this second sub-step a2) is to allow a demethylation, for example, by saponification, of the galacturonic acids of pectins not solubilized during the execution of the first sub-step a1). As a result of this demethylation, the pectins see their solubility increase in an aqueous medium.

The mixture may contain calcium and magnesium ions, which are likely to interact with the carboxylate functions of pectins and thus gelify the pectins.

In order to avoid the gelation of pectins, it is also possible to consider the addition, during the execution of the second sub-step a2), of a chelating agent intended to preferentially form complexes with the calcium and magnesium ions and thus make them unavailable for the gelation of pectins. This chelating agent may comprise cyclohexane diamine tetraacetic acid (CDTA) or ethylene diamine tetraacetic acid (EDTA).

Thus, the execution of these two sub-steps a1) and a2) leads to the formation of a first liquid residue PRL (the supernatant) and a first solid product PPS. The first solid product PPS comprises mainly holocellulose (that is a cellulose cell Cell/xyloglucan Xg complex) while the first liquid residue PRL comprises the free sugars, the oligosaccharides and the pectins initially present in the primary walls of plant cells.

Xyloglucan Xg has a high affinity for cellulose Cell. Also, in order to separate these two species, it is proposed in the present disclosure to proceed with the execution of a second step b).

Notably, the second step b) comprises mixing the first solid product (“holocellulose”) with a second solution, the second solution comprising the strong base at a concentration of between 1 mol/L and 3 mol/L, advantageously between 2 mol/L and 3 mol/L, for example, equal to 2.5 mol/L. The second step leads to the separation of the cellulose Cell and xyloglucan Xg contained in the first solid product PPS.

The second step b) can be carried out at a temperature greater than 20° C., advantageously greater than 35° C., even more advantageously greater than 50° C.

The second step b) can be of a duration greater than 30 min, advantageously greater than 45 min, even more advantageously greater than 1 hour.

The purity of the cellulose Cell thus obtained is greater than 75% or even greater than 85%, while the purity of xyloglucan Xg is greater than 80% or even greater than 90%.

Moreover, the extraction yield of xyloglucan Xg can reach values of the order of 5%, or even higher, with respect to the dry mass of plant cells initially considered when implementing the method according to the present disclosure.

Additionally, xyloglucan Xg is only slightly or not chemically affected during the execution of the first and second steps.

The plant cells considered for the implementation of the method according to the present disclosure can comprise plant cells of dicotyledonous plants, and more particularly from apples or citrus fruits.

Moreover, the proposed method can be limited to carrying out only two steps a) and b). These steps are simple to implement and impose relatively mild chemical conditions to preserve xyloglucan Xg in its polymeric form while offering high yields and purities.

Finally, the proposed method does not use any chemical species (such as sodium chlorite NaClO₂) likely to present an environmental toxicity.

Particularly advantageously, it may be considered to carry out step b) at a moderate temperature.

Notably, the second step b) can be carried out at a temperature of between 10° C. and 50° C., advantageously between 10° C. and 35° C., even more advantageously between 10° C. and 25° C., still more advantageously between 15° C. and 25° C.

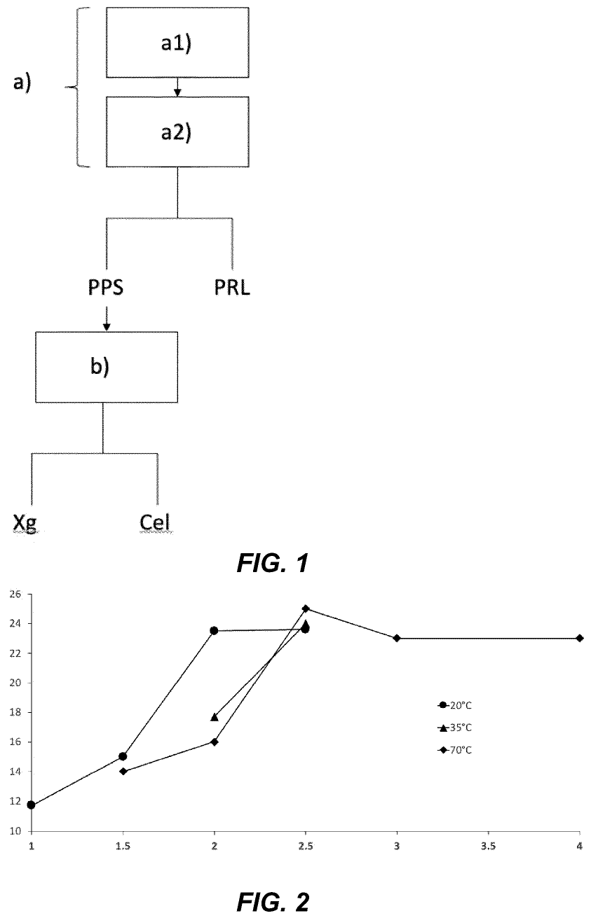

In this respect, FIG. 2 graphically exemplifies the mass extraction yields (hereinafter “yield,” in “%”) of xyloglucan from the first product along the vertical axis based on the concentration of strong base, notably sodium hydroxide, (in mol/L) along the horizontal axis. Notably, this graph depicts yields for different temperatures, and more particularly for a step b) carried out at 20° C., 35° C. and 70° C. From this graph, it is clear that the concentration of strong base to be considered for obtaining a given yield decreases as the temperature at which step b) is carried out decreases.

The consideration of a temperature at which step b) is carried out is particularly advantageous in several respects. Notably, this helps to limit energy consumption as well as strong base consumption.

Moreover, this last aspect eases the extraction conditions by limiting the concentration of strong base. Notably, the considerations of a temperature less than 35° C. and a lower concentration of strong base make the extraction conditions less aggressive and enable xyloglucan with a higher molar mass to be obtained.

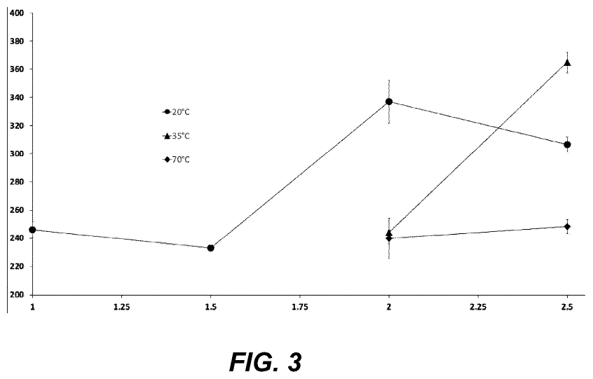

In this respect, FIG. 3 graphically shows the evolution of the molar mass of xyloglucan obtained at the end of step b) based on the concentration of strong base and for different temperatures (20° C., 35° C. and 70° C.) at which step b) is carried out. Notably, the vertical axis indicates the molar mass by mass (in “103 g/mol”) based on the concentration of strong base, notably sodium hydroxide (in mol/L) along the horizontal axis. More particularly, the “round” patterns depict the molar masses by mass obtained at 20° C., the “triangle” patterns depict the molar masses by mass obtained at 35° C., and the “diamond” patterns depict the molar masses by mass obtained at 70° C.

Thus, and advantageously, the concentration of strong base in the second solution is between 1.5 mol/L and 2.5 mol/L, advantageously between 2 mol/L and 2.5 mol/L.

Still advantageously, the execution of step b) can meet the following conditions:
if the temperature at which the second step is carried out is greater than 35° C., the concentration of strong base is greater than 2 mol/L, advantageously between 2 mol/L and 2.5 mol/L, and
if the temperature at which the second step is carried out is less than 35° C., the concentration of strong base is less than 2.2 mol/L.

The following description discloses an example implementation of the extraction method according to the present disclosure.

### Example Implementation of the Extraction Method

In this example, 30 g of apple pomace powder is dried for 8 hours in a 60° C. oven.

According to this example, the first sub-step comprises mixing the apple pomace with 900 mL of deionized water in a 2 L three-necked flask. The mixture is heated to a temperature of about 90° C. for one hour in an oil bath.

In order to carry out the second sub-step, the temperature of the mixture is reduced to 70° C., and 18 g of sodium hydroxide (0.5 mol/L of sodium hydroxide) is added to the mixture, with stirring.

The second sub-step of this example comprises heating the mixture to 80° C. for 2 hours with mechanical stirring.

Following the second sub-step, the mixture is centrifuged at about 8,000 g for 15 min. A solid (holocellulose) is recovered, redispersed in deionized water then recentrifuged 3 times for better washing.

The mass yield of holocellulose recovered from the second sub-step is 20 m %. The osidic composition of the first liquid residue PRL after dialysis reveals the presence of starch, pectins and other cohemicelluloses. Furthermore, CP-MAS Solid-State NMR analysis of the first liquid residue after drying revealed a significant presence of proteins and lipid polymers. The majority of aromatic compounds (lignin and tannins) appear to be present in the first liquid residue.

The holocellulose obtained from the second sub-step is then processed in a second step. The holocellulose is then redispersed in 200 mL (about 1/30 w/w) of a solution containing a total of 20 g of sodium hydroxide, at 70° C. The dispersion is heated to a temperature of 70° C. for 2 hours with mechanical stirring.

The dispersion is then centrifuged at about 10,000 g for 30 min, and the supernatant (Xg) and residue (Cell) are separated.

The residue (Cell) is redispersed and recentrifuged under the same conditions.

The supernatants (Xg) are collected and dialyzed against deionized water until the conductivity of the dialysis water has stabilized to that of the deionized water.

The residues (Cell) are washed by redispersions in deionized water and successive centrifugations under the same conditions as previously.

The osidic composition, obtained by hydrolysis of the supernatant (Xg) with trifluoroacetic acid, reveals a majority xyloglucan fraction (glucose, xylose, galactose, fucose, arabinose). CP-MAS NMR analysis reveals a negligible amount of protein in the fraction of xyloglucan and the cellulose fraction. The osidic composition of the cellulose, obtained by hydrolysis of the solid fraction with sulfuric acid, is mainly glucose, with the presence of other residual minority sugars (mannose, xylose), revealing the presence of residual hemicelluloses.

The yield of the final supernatant fraction (Xg) is 5 m % of the initial dry matter mass.

The estimated purity of the final supernatant fraction of xyloglucan after analysis is 95%.

The implementation of the extraction method described above demonstrates the possibility of obtaining xyloglucan and cellulose simply and at relatively high purity levels.

The cellulose obtainable by the extraction method was able to be characterized according to the present disclosure.

Notably, it was observed that, despite the consideration of a high sodium hydroxide concentration for the execution of step b), it is possible to extract cellulose I. Crystallinity studies using x-ray diffraction or CP-MAS solid-state NMR methods have been carried out.

The purity of the cellulose was determined by solid NMR (CP-MAS) and by acid hydrolysis and sugar analysis (osidic composition). Solid-state NMR reveals the absence of proteins in the residual cellulose fraction, as well as fatty acids or pectins. The osidic composition reveals the presence of residual cohemicelluloses still adsorbed on cellulose. These hemicelluloses can be considered beneficial for cellulose recovery, since they are essential to the thickening rheological behavior of cellulose microfibrils.

Thus, the purity of the cellulose fraction is estimated at about 85%, with the remaining 15% of impurities essentially due to co-hemicelluloses still adsorbed on the cellulose.

Given the purity observed, the cellulose thus extracted can be properly exploited. Notably, this so-called parenchyma cellulose (that is primary wall cellulose) is obtained in the form of cellulose microfibrils. These microfibrils are highly purified and numerous applications can be envisaged, notably in the materials or paper industries.

From the conceivable applications, it is possible to consider a coating or molding composition for composites or mastic containing additives based on cellulose microfibrils (see document [2] cited at the end of the description).

It is also possible to consider these cellulose microfibrils for improving the strength and holding power of paper (see document [3] cited at the end of the description).

The cellulose microfibrils can also be used in the cosmetics industry (see document [4] cited at the end of the description).

It was also found that xyloglucan extracted in accordance with the principles of the present disclosure can have a purity of between 90% and 95% (the latter is notably obtained by osidic composition, solid NMR (CP-MAS), Bradford assay and ¹H liquid NMR).

The osidic composition of the hemicellulose fraction (Xg) obtained at the end of extraction is as follows:
Glucose: 39.2 mol %;
Xylose: 31.6 mol %;
Galactose: 12.2 mol %;
Fucose: 6.7 mol %;
Arabinose: 6 mol %;
Mannose: 4.4 mol %.

Xyloglucan obtained at the end of extraction contains fucose and arabinose sugars in small proportions in accordance with what is expected of Xg of primary walls.

The number molar mass (Mn) of xyloglucan measured by steric exclusion chromatography at the end of extraction is between 60 kDa and 100 kDa, according to certain extraction conditions.

The Bradford assay is used to determine a residual protein content in xyloglucan, estimated at about 3 g/kg of material, that is a protein content of about 0.3 m %.

Xyloglucan extracted from primary walls by the extraction method according to the present disclosure can be used for the synthesis of xyloglucan oligomers. Notably, and in the context of oligomer synthesis, given its purity, xyloglucan can undergo enzymatic hydrolysis. The level of purity of the xyloglucan extracted under the terms of the present disclosure favors the enzymatic activity of the enzymes used, and notably glucanase-type enzymes. Xyloglucan oligomers can be used as compounds for their enzymatic activity, similar to the use disclosed in the document [5] cited at the end of the description.

Xyloglucan extracted from primary walls can also be used as an additive to form packaging films notably to improve the mechanical properties thereof (see document [6] cited at the end of the description).

Of course, the present disclosure is not limited to the described embodiments and variant embodiments may be envisaged without departing from the scope of the invention as defined by the claims.

### REFERENCES

[1] Ma, Y., Luo, J. & Xu, Y. “Co-preparation of pectin and cellulose from apple pomace by a sequential process,” J Food Sci Technol 56, 4091-4100 (2019);
[2] FR2867193A1;
[3] U.S. Pat. No. 9,399,838B2;
[4] [EP0820267A1;
[5] EP01972226A;
[6] U.S. Pat. No. 9,534,096B2.

1. A method for extracting xyloglucan contained in the primary walls of plant cells of a dicotyledonous plant, the method comprising carrying out the following steps:
a) a first step including mixing primary walls of plant cells, whether native or extracted, with a first aqueous solution and to which a strong base is added at a concentration of between 0.1 mol/L and 0.75 mol/L, the execution of the first step leading to the formation of a first liquid residue and a first solid product, the first solid product comprising mainly holocellulose; and
b) a second step of mixing the first product with a second solution, the second solution comprising the strong base at a concentration of between 1 mol/L and 3 mol/L, the second step leading to the separation of the cellulose and xyloglucan contained in the first product.

2. The method of claim 1, wherein the first step
a) is carried out in two successive sub-steps comprising:
a1) a first sub-step comprising mixing the plant cells with the first aqueous solution, the mixture of the first aqueous solution with the plant cells having a pH of between 3 and 7; and
a2) a second sub-step comprising adding the strong base, at a concentration of between 0.1 mol/L and 0.75 mol/L to the mixture obtained at the end of the first sub-step a1).

3. The method of claim 2, wherein the first aqueous solution comprises an acid species such that the pH resulting from mixing the first aqueous solution and the plant cells is between 3 and 7.

4. The method of claim 3, wherein the acid species comprises at least one of the species selected from: citric acid, acetic acid, nitric acid.

5. The method of claim 2, wherein the pH of the mixture of the first aqueous solution and the plant cells results from the presence of acid compounds in the plant cells.

6. The method of claim 2, wherein the first sub-step a1) is carried out at a temperature greater than 80° C. and is of a duration greater than 30 min.

7. The method of claim 2, wherein the second sub-step a2) is carried out at a temperature greater than 60° C. and is of a duration greater than 1 hour.

8. The method of claim 2, wherein the second step b) is carried out at a temperature greater than 50° C. and is of a duration greater than 1 hour.

9. The method of claim 2, wherein the strong base comprises at least one of the compounds selected from: NaOH, KOH.

10. The method of claim 2, wherein the method uses neither sodium chlorite nor calcium chloride.

11. The method of claim 2, wherein the dicotyledonous plant comprises one of the species selected from: apple or citrus fruits.

12. The method of claim 1, wherein the method is limited to the execution of the first step a) and of the second step b).

13. The method of claim 1, wherein the second step b) is carried out at a temperature of between 10° C. and 50° C.

14. The method of claim 13, wherein the concentration of strong base in the second solution is between 1.5 mol/L and 2.5 mol/L.

15. The method of claim 1, wherein, if the temperature at which the second step is carried out is greater than 35° C., the concentration of strong base is greater than 2 mol/L, and, if the temperature at which the second step is carried out is less than 35° C., the concentration of strong base is less than 2.2 mol/L.

16. The method of claim 1, wherein the strong base is added at a concentration of between 0.25 mol/L and 0.5 mol/L in the first step a), and the second solution comprises the strong base at a concentration of between 2 mol/L and 3 mol/L in the second step b).

17. The method of claim 2, wherein the mixture of the first aqueous solution with the plant cells has a pH of between 4 and 5 in the first sub-step a1), and wherein the second sub-step a2) comprises adding the strong base, at a concentration of between 0.25 mol/L and 0.5 mol/L to the mixture obtained at the end of the first sub-step a1).

18. The method of claim 3, wherein the pH resulting from mixing the first aqueous solution and the plant cells is between 4 and 5.

19. The method of claim 13, wherein the second step b) is carried out at a temperature of between 15° C. and 25° C.

20. The method of claim 14, wherein the concentration of strong base in the second solution is between 2 mol/L and 2.5 mol/L.
